(19) United States
(12) Patent Application Publication
(10) Pub. No.: US 2024/0107086 A1
(43) Pub. Date: Mar. 28, 2024

(54) Multi-layer Foveated Streaming

(71) Applicant: Apple Inc., Cupertino, CA (US)

(72) Inventors: Chaminda N. Vidanagamachchi, San Jose, CA (US); Matthew J. Yaeger, Tustin, CA (US)

(21) Appl. No.: 18/457,747

(22) Filed: Aug. 29, 2023

Related U.S. Application Data
(60) Provisional application No. 63/376,855, filed on Sep. 23, 2022.

(51) Int. Cl. H04N 21/2343; H04N 21/442

(52) U.S. Cl. CPC H04N 21/234363; H04N 21/44218

(57) ABSTRACT

A non-transitory computer readable medium may include instructions that, when executed by at least one computer processor, cause the at least one computer processor to obtain an initial image frame at a first resolution. The initial frame may include a first number of pixels. The at least one computer processor may be caused to generate a downscaled image frame from the initial image frame at a second resolution. The at least one computer processor may be caused to obtain one or more subframes of the initial image frame. Each of the subframes may include a portion of the number of pixels. The at least one computer processor may be caused to transmit, to a playback device, the downscaled image frame and at least one of the subframes. The downscaled image frame and the subframe may be combinable to form a target frame comprising subframes of differing resolutions.

### BACKGROUND

Foveated streaming may be used in rendering operations including two-dimensional (2D) media and/or three-dimensional (3D) media. In applications that involve foveated streaming, a foveated near-eye display may be used to render high resolution images along users' eye gaze direction, along with low resolution peripheral images. Foveated rendering is a rendering technique which uses an eye tracker integrated with the foveated near-eye display to reduce a rendering workload by greatly reducing an image quality in peripheral vision (outside of the zone gazed by the fovea). Existing foveated streaming techniques fail to consistently maintain the high resolution in a region of interest following users' eye gaze direction.

### BRIEF DESCRIPTION OF THE DRAWINGS

FIG. 1 shows an example of a content delivery system providing multi-layer foveated streaming in accordance with one or more embodiments.

FIG. 2 shows an example of a playback system rendering multi-layer foveated streaming in accordance with one or more embodiments.

FIG. 3 shows, in flowchart form, an example technique for providing and rendering portions of a multi-layer foveated stream in accordance with one or more embodiments.

FIG. 4 shows, in flowchart form, a technique for providing a multi-layer foveated stream for playback in accordance with one or more embodiments.

FIG. 5 shows, in flowchart form, a technique for creating a combined image frame based on a multi-layer foveated stream in accordance with one or more embodiments.

FIG. 6 shows, in block diagram form, a simplified system diagram of a multi-layer streaming system in accordance with one or more embodiments.

FIG. 7 shows, in block diagram form, a simplified system diagram of a multifunction electronic device in accordance with one or more embodiments.

### DETAILED DESCRIPTION

This disclosure is directed to systems, methods, and computer readable media configured to combine multiple layers of foveated media in streaming applications. In some embodiments, multi-layer foveated streaming techniques disclosed herein consistently maintain a high quality in a region of interest following users' head pose or users' eye gaze direction. In one or more embodiments, the multi-layer foveated streaming techniques may be performed by at least one content delivery system and at least one playback system. The content delivery system is configured to provide the playback system with encoded subframes that may be combined to consistently generate high quality (e.g., high resolution) images. The content delivery system may control a size of the encoded subframes in accordance with current bandwidth information for communication between the content delivery system and the playback system, or based on processing capabilities of the playback system (e.g., based on the ability of decoding circuitry at the playback system to decode the encoded subframes, which may vary according to size and resolution of the encoded subframes).

In some embodiments, the content delivery system may obtain an initial image frame for a foveated stream. The content delivery system may generate encoded comparator image subframes and an encoded downscaled image frame based on the initial image frame. The encoded comparator image subframes may be subframes based on the initial image frame that include at least one subframe representative of a difference between an original subframe and a re-scaled subframe of the initial image frame. The encoded downscaled image frame is a downscaled version of the initial image frame. The content delivery system may be configured to provide the encoded comparator image subframes and the encoded downscaled image frame to a playback device for rendering.

In some embodiments, the playback system obtains the encoded comparator image subframes and the encoded downscaled image frame from the content delivery system. Further, the playback system may receive head pose/gaze information corresponding to a user. The playback system may decode at least one subframe out of the subframes received corresponding to a fovea in the initial image frame. As such, the initial image frame may be a foveated image frame. The fovea may be identified to include a region of interest based on the head pose/gaze information. Once the subframe with the region of interest is selected, this subframe and the encoded downscaled image frame may be decoded and combined into a combined image frame for playback.

In the aforementioned multi-layer foveated streaming techniques, the content delivery system emulates functionality of the playback system to preemptively identify possible loss in quality of the region of interest in the foveated stream. Based on a bandwidth availability or processing capabilities of the playback system, different sizes of the encoded image frames and subframes may be provided to the playback system. The sizes may be automatically selected to vary stream transport time between the content delivery system and the playback system. As described above, selecting a subframe for the region of interest may be based on users' head pose/gaze information, which allows the playback device to reduce power consumption by only processing the region of interest with the downscaled image frame to generate high quality combined image frame for playback. In some embodiments, the playback system is configured to apply edge smoothing to improve quality across the combined image frame boundaries. The playback system may be also configured to render the combined image frame using High Dynamic Range (HDR) capabilities.

The content delivery system and the playback system may be configured in accordance with a power target. The power target may be a threshold of power consumption that the content delivery system and/or the playback system are configured to maintain. In this regard, the multi-layer foveated streaming techniques may be implemented to meet the power target by reducing power consumption in the content delivery system, the playback system, or both. Reduction of the power consumption in these systems may include reducing processing time and or processing power in one or more operations. For example, to reduce power consumption at the content delivery system, the content delivery system may increase the scaling of the downscaled image frame to provide a relatively small encoded downscaled image frame to the playback system.

Herein the terms “high” and “low” are relative values of quality (e.g., resolution allocation and/or dynamic range) corresponding to individual frames. For example, a frame may be considered to include a low resolution as long as the frame includes a resolution allocation that is lower than the resolution allocations of a current resolution allocation being encoded or the resolution allocation of other frames in the same media stream. In some embodiments, “low resolution” or “low frame rate” may indicate a relative resolution or frame rate to other frames in the combined media stream, considered to be “high resolution” or “high frame rate” frames.

In the following description, for purposes of explanation, numerous specific details are set forth to provide a thorough understanding of the disclosed concepts. As part of this description, some of this disclosure's drawings represent structures and devices in block diagram form to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming but would nevertheless be a routine undertaking for those of ordinary skill in the art of image capture having the benefit of this disclosure.

For purposes of this disclosure, the term “camera system” refers to one or more lens assemblies along with the one or more sensor elements and other circuitry utilized to capture an image. For purposes of this disclosure, the “camera” may include more than one camera system, such as a stereo camera system, multi-camera system, or a camera system capable of sensing the depth of the captured scene.

A physical environment refers to a physical world that people may sense and/or interact with without aid of electronic systems. Physical environments, such as a physical park, include physical articles, such as physical trees, physical buildings, and physical people. People may directly sense and/or interact with the physical environment, such as through sight, touch, hearing, taste, and smell.

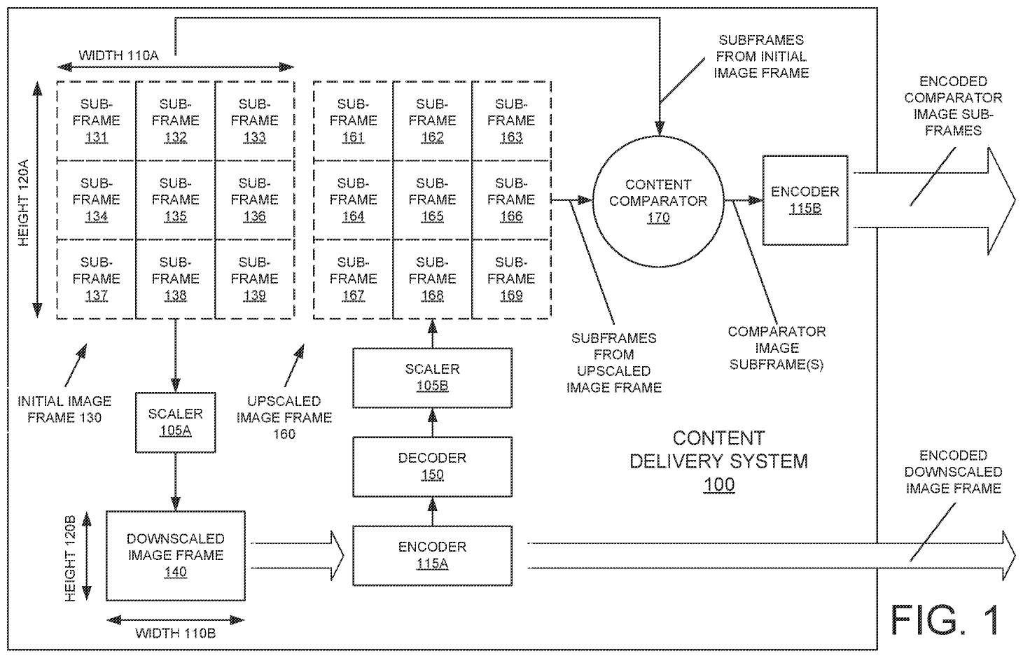

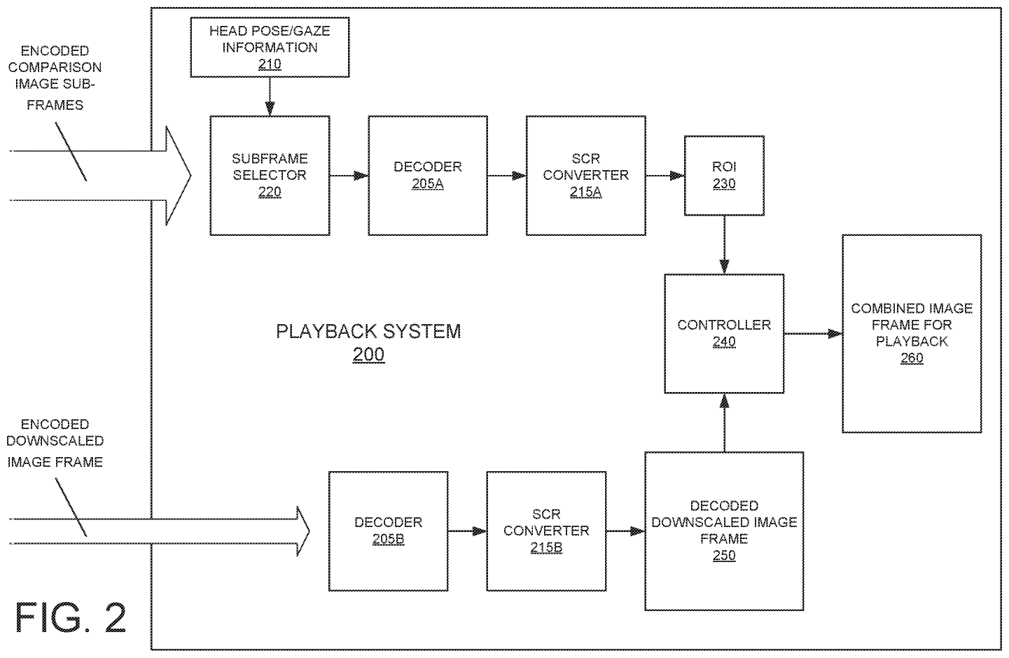

Referring to FIG. 1, an example diagram shows a content delivery system 100 in accordance with one or more embodiments. The content delivery system 100 may obtain an initial image frame 130 for a foveated stream. The content delivery system 100 may generate encoded comparator image subframes and an encoded downscaled image frame based on the initial image frame 130. The encoded comparator image subframes may be subframes representative of the initial image frame 130 that include at least one subframe representative of a difference between an original subframe 131-139 and a re-scaled subframe 161-169 of the initial image frame 130. The encoded downscaled image frame is a downscaled version of the initial image frame 130. The content delivery system 100 may be configured to provide the encoded comparator image subframes and the encoded downscaled image frame to a playback device 200 for rendering. In some embodiments, providing the encoded comparator image subframes and the encoded downscaled image frame simultaneously to the playback device 200 prevents decoding of duplicate information before rendering. That is, the playback device 200 does not receive duplicate information in the two streams. The playback system 200 will be described in detail in reference to FIG. 2.

In some embodiments, the content delivery system 100 is shown to obtain the initial image frame 130 having multiple subframes 131-139. The initial image frame 130 includes a width 110A and a height 120A. In one or more embodiments, each subframe of the multiple subframes 131-139 includes multiple pixels and/or pixel blocks. In the example of FIG. 1, the initial image frame 130 is downscaled using a scaler 105A to create a downscaled image frame 140. The downscaled image frame 140 may have a width 11013 and a height 12013 that are scaled down by a downscaling factor to the width 110A and the height 120A, respectively. The downscaling factor may be the same or different for the widths and heights. The scaler 105A may be configured to downscale the initial image frame 130 by a predetermined downscaling factor or by a dynamic downscaling factor.

The downscaled image frame 140 may be encoded using an encoder 115A. The encoder 115 may be configured to compress the image content of the downscaled image frame 140 into an encoded downscaled image frame. The content delivery system 100 may provide the encoded downscaled image frame to the playback system 200 directly. In some embodiments, the downscaled image frame 140 is scaled down by a common factor of “N” on each direction to reduce a gradient differential between the initial image frame 130 and the upscaled image frame 160.

In one or more embodiments, the content delivery system 100 may also provide the encoded downscaled image frame to its own decoder 150. The decoder 150 may be configured to decode the encoded downscaled image frame in a manner that mimics the decoding capabilities of the playback system 200. Once the encoded downscaled image frame is decoded, the content delivery system 100 may use a scaler 105B to generate an upscaled image frame 160. The upscaled image frame 160 may have the width 110A and the height 120A of the initial image frame 130. As a result, the upscaled image frame 160 may include multiple subframes 161-169 that closely resemble the subframes 131-139 of the initial image frame 130.

In some embodiments, at the content comparator 170, the foveated region in the subframes 131-139 of the initial image frame 130 includes a target region (e.g., the fovea) compared to a corresponding area in the subframes 161-169 of the upscaled image frame 160 to generate one or more comparator image subframes. In this case, the comparator image subframes are subframes representative of differences between the target region and the corresponding area. In other embodiments, at the content comparator 170, the subframes 131-139 of the initial image frame 130 are compared to the subframes 161-169 of the upscaled image frame 160 to generate comparator image subframes. The comparator image subframes are subframes representative of differences between the two sets of subframes. In yet other embodiments, the encoded comparator image subframes may include all subframes representative of differences between the subframes 131-139 and the subframes 161-169. In all embodiments, the comparator image subframes may be provided to the encoder 1153. Once the comparator image subframes are encoded, these encoded comparator image subframes may be provided to the playback system 200 as the encoded comparator image subframes.

The initial image frame 130 may be a frame out of multiple frames in a foveated stream. As such, the content delivery system 100 is configured to provide (e.g., transmit, send) the encoded comparator image subframes and the encoded downscaled image frame to the playback device 200 at a same time, or including information that associates the encoded comparator image subframes with the corresponding encoded downscaled frames.

The content delivery system 100 may be configured to encode the multiple frames and subframes to meet a predefined or dynamic power consumption target. Changes in the power consumption target may directly affect the scaling provided by the scaler 105A. For example, the downscaled image frame 140 may be larger in size when the power consumption target is high.

In some embodiments, the scaler 105A and the scaler 105B may be a same scaler 105 configured to perform two distinct and different scaling operations. Further, the encoder 115A and the encoder 115B may be a same encoder 115 configured to perform multiple encoding operations based on an input received. For example, the encoder 115 may perform one type of an encoding operation based on whether the input is a portion of an individual subframe or the entirety of the downscaled image frame 140. The encoder 115 and the decoder 150 may be configured to perform encoding/decoding in accordance with a High Efficiency Video Coding (HEVC) standard to create a compressed video bitstream (e.g., a sequence of decoded frames).

Referring to FIG. 2, an example diagram shows a playback system 200 in accordance with one or more embodiments. The playback system 200 may obtain the encoded comparator image subframes and the encoded downscaled image frame from the content delivery system 100 described in reference to FIG. 1. Further, the playback system 200 may receive head pose/gaze information 210 corresponding to a user. The playback system 200 may decode at least one subframe out of the subframes received corresponding to a fovea in the initial image frame 130. A region of interest (ROI) 230 may be identified based on the head pose/gaze information 210 and the fovea. Once the subframe with the ROI 230 is selected, this subframe and the encoded downscaled image frame may be decoded and combined into a high quality combined image frame for playback 260.

In FIG. 2, the playback system 200 is shown to obtain the encoded comparator image subframes from the content delivery system 100. The encoded comparator image subframes may be provided to the playback system 200 via multiple streams. The playback system 200 may include a sub-frame selector 220 configured to obtain head pose/gaze information 210 and select one of the streams corresponding to a subframe including the fovea based on the head pose/gaze information 210. The sub-frame selector 220 determines whether the selected stream includes a subframe or portions of subframes including the fovea. At this point, a decoder 205A may decode the selected stream of the encoded comparator image subframes. A decoded version of the selected stream is then provided to a Scaler, Rotator, Color (SRC) converter 215A to obtain the ROI 230. The SRC converter 215A enables the playback system 200 to implement a human perception-based colored image enhancement algorithm that provides color constancy, space modulation engine, and Dynamic Range Compression (DRC) to the ROI 230. The SRC converter 215A may be configured to identify image enhancements that may be used to achieve color and lightness rendition along with the DRC and any additional rendering parameters (e.g., resolution) for the ROI 230. Once the ROI 230 is obtained, the ROI 230 is provided to the controller 240.

In FIG. 2, the playback system 200 is shown to obtain the encoded downscaled image frame from the content delivery system 100. The encoded downscaled image frame may be provided to the playback system 200 via a single stream. The playback system 200 may include a decoder 205B configured to decode the encoded downscaled image frame. A decoded version of the encoded downscaled image frame is then provided to an SRC converter 215B to obtain a decoded downscaled image frame 250. The SRC converter 215B may be configured to identify image enhancements that may be used to achieve color and lightness rendition along with the DRC and any additional rendering parameters (e.g., resolution) for the decoded downscaled image frame 250. Once the decoded downscaled image frame 250 is obtained, the decoded downscaled image frame 250 is provided to the controller 240.

The controller 240 may be one or more processors configured to obtain and combine the ROI 230 and the decoded downscaled image frame 250. In this combination, the controller 240 generates a combined image frame for playback 260. The combined image frame for playback 260 results is an image frame including a high-level of detail in the fovea. The combined image frame for playback 260 may be target frame provided to a rendering module for upscaling and rendering before playback.

The playback system 100 may be configured to decode and combine the multiple frames and subframes to meet the predefined or dynamic power consumption target. Changes in the power consumption target may directly affect the decoding provided by the decoder 205. For example, the ROI 230 may be larger in size or have a larger resolution when the power consumption target is high.

In some embodiments, the decoder 205A and the decoder 205B may be a same decoder 205 configured to perform multiple decoding operations based on an input received. For example, the decoder 205 may perform one type of a decoding operation based on whether the input is a portion of an individual subframe or the entirety of the encoded downscaled image frame. Similar to the encoder 115 and the decoder 150, the decoder 205 may be configured to perform encoding/decoding in accordance with the HEVC standard to create the compressed video bitstream (e.g., a sequence of decoded frames). The SRC converter 215A and the SRC converter 2153 may be a same SRC converter 215 configured to identify space conversion parameters associated with the ROI 230 and the decoded downscaled image frame 250.

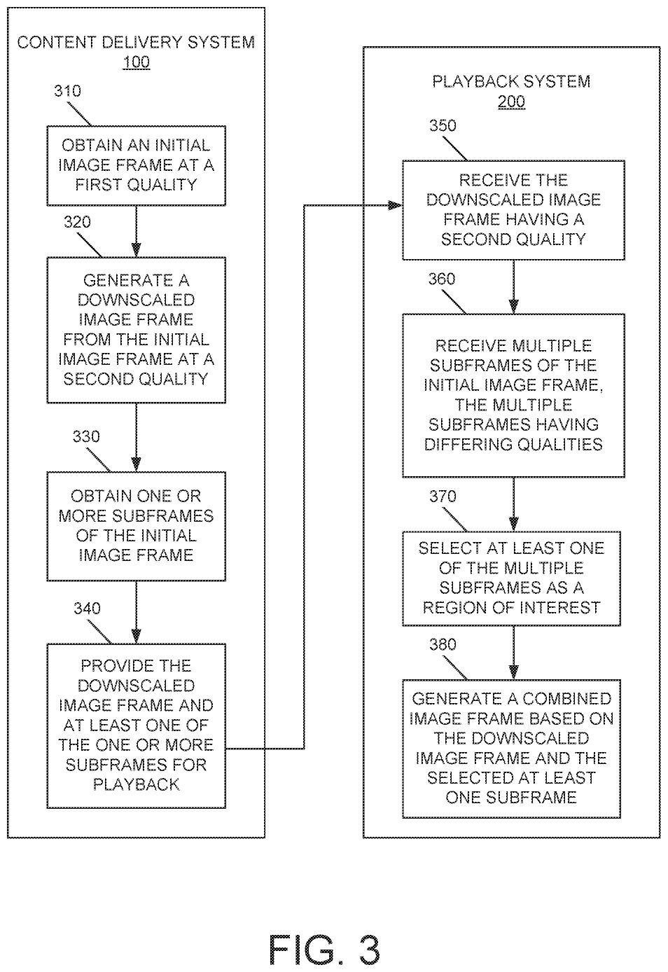

FIG. 3 is a flow diagram of a multi-layer foveation streaming process performed by the content delivery system 100 of FIG. 1 in communication with the playback system 200 in FIG. 2. In particular, the flow diagram shows processes for obtaining an initial image frame 130 including a first quality (e.g., resolution or dynamic range), generating a downscaled image frame 140 from the initial image frame 130 at a second quality, obtaining one or more subframes of the initial image frame 130, and transmitting the downscaled image frame and at least one of the one or more subframes. The content delivery system 100 may include an electronic device or system configured to generate multiple layers of foveated streaming content. The playback system 200 may be an electronic device or system that receives the layers of foveated streaming content and combining these layers into a target frame comprising subframes of differing quality. In the target frame, an area representative of the fovea may include a high quality while areas outside the fovea and a foveated region may include a low quality.

In one or more embodiments, to reduce the processing used for decoding encoded frames/subframes at the playback system 200, the content delivery system 100 provides a lower quality first stream including the encoded downscaled image frame and a higher quality secondary stream including the encoded comparator image subframes.

In the multi-layer foveated streaming techniques, the content delivery system 100 emulates functionality of the playback system 200 to preemptively identify possible loss in quality of pixels in a fovea in the foveated stream. Based on a bandwidth availability, different sizes of the encoded image frames and subframes may be provided to the playback system 200. The sizes may be automatically selected to vary stream transport time between the content delivery system 100 and the playback system 200. As described above, selecting a subframe for the foveation region may be based on users' head pose/gaze information 210, which allows the playback device 200 to reduce power consumption by only combining a region of interest including the fovea in the foveation region with the downscaled image frame to generate high quality combined image frame for playback 260. Further, the playback system 200 is configured to apply edge smoothing to improve quality across the combined image frame boundaries in the foveation streaming.

In the example of FIG. 3, the content delivery system 100 obtains an initial image frame at a first quality in block 310. The content delivery system 100 may obtain the initial image frame from image streams captured directly using one or more camera devices, and/or from cameras systems that are communicably coupled to the content delivery system 100 and/or the playback device 200. Additionally, or alternatively, the me content delivery system 100 may obtain the image from storage, such as a local storage within the content delivery system 100, or a remote source, such as network storage or from another storage device. The multiple media streams may be prelabeled in accordance with their respective types (e.g., 2D content, 3D content, focal point in a fovea, surrounding points in a foveation setting, and the like). In some embodiments, the content delivery system 100 is provided information for selecting one or more frames from any one or more media streams.

At block 320, the content delivery system 100 generates a downscaled image frame 140 from the initial image frame 130 at a second quality. As shown in FIG. 1, the content delivery system 100 may divide the initial image frame 130 into multiple original subframes 131-139. The content delivery system 100 may determine that a portion of at least one subframe includes a fovea. As described above, the fovea may be a region in at least a part of a subframe that indicates a region of interest in the initial image frame. The downscaled image frame 140 may be a version of the initial image frame 130 that is scaled down from an original size using the scaler 105. Thus, the downscaled image frame 140 may include downscaled versions of all the original subframes 131-139. For example, if a scaling factor is defined as N=2, the initial image frame 130 having a width 110A and a height 120A equal to 3,600 pixels may be downscaled to the downscaled image frame 140 having a width 11013 and a height 12013 equal to 1,800 pixels.

At block 330, the content delivery system 100 obtains one or more subframes of the initial image frame 130. The one or more subframes may be the comparator image subframes generated by the content comparator 170. As described above, at the content comparator 170, the fovea in the subframes 131-139 of the initial image frame 130 is a target region compared to a corresponding area in the subframes 161-169 of the upscaled image frame 160 to generate one or more comparator image subframes. In this case, the comparator image subframes are subframes representative of differences between the target region and the corresponding area. In other embodiments, at the content comparator 170, the subframes 131-139 of the initial image frame 130 are compared to the subframes 161-169 of the upscaled image frame 160 to generate comparator image subframes. Thus, the comparator image subframes are subframes representative of differences between the two sets of subframes.

In one or more embodiments, the initial image frame 130 may include a set of image parameters that indicate a particular type of media content in the media streams, such as 2D or 3D content. The image parameters may indicate that the media streams includes linear media content to be decoded and rendered using 2D drives and/or a configuration for handling 2D content. The image parameters may indicate that the media stream includes interactive or immersive media content to be decoded and rendered using interactive media drives and/or a configuration for handling interactive content. In some embodiments, the interactive content may be 2D content foveated to provide a focus in the region of interest. The interactive content may be 3D content foveated to immerse a viewer in a virtual environment.

In one or more embodiments, the set of image parameters indicate a quality allocation included in the media streams. In one example, the image parameters may indicate that the media streams includes media content including a specific resolution allocation. Further, the image parameters may indicate that the media streams includes one or more specific resolution allocations. In some embodiments, the resolution allocations may be different between frames of the same media stream. Further, the resolution allocations may be different while remaining within a common resolution range. In another example, three frames in a media stream may have different resolution allocations while remaining above a common resolution allocation threshold.

In one or more embodiments, the set of image parameters indicate a frame rate allocation included in a media stream. The image parameters may indicate that the media stream includes media content including a specific frame rate. Further, the image parameters may indicate that that the media stream includes one or more specific frame rates. In some embodiments, the frame rates may be different between frames of the same media stream. Further, the frame rates may be different while remaining within a common frame rate range. For example, three groups of frames in a media stream may have different frame rates while remaining above a common frame rate threshold.

At block 340, the content delivery system 100 provides the downscaled image frame and at least one of the subframes for playback to the playback system 200. The content delivery system 100 may provide the encoded comparator image subframes and the encoded downscaled image frame in the manner described in reference to FIG. 1.

At block 350, the playback system 200 receives the downscaled image frame at a second quality. Here, the playback system 200 may receive the encoded downscaled image frame in the manner described in reference to FIG. 2.

At block 360, the playback system 200 receives multiple subframes of the initial image frame. The subframes may have different qualities. Here, the playback system 200 may receive the encoded comparator image subframes in the manner described in reference to FIG. 2. In some embodiments, these subframes are representative of a differential in a fovea between subframes in the initial image frame 130 and subframes in the upscaled image frame 160.

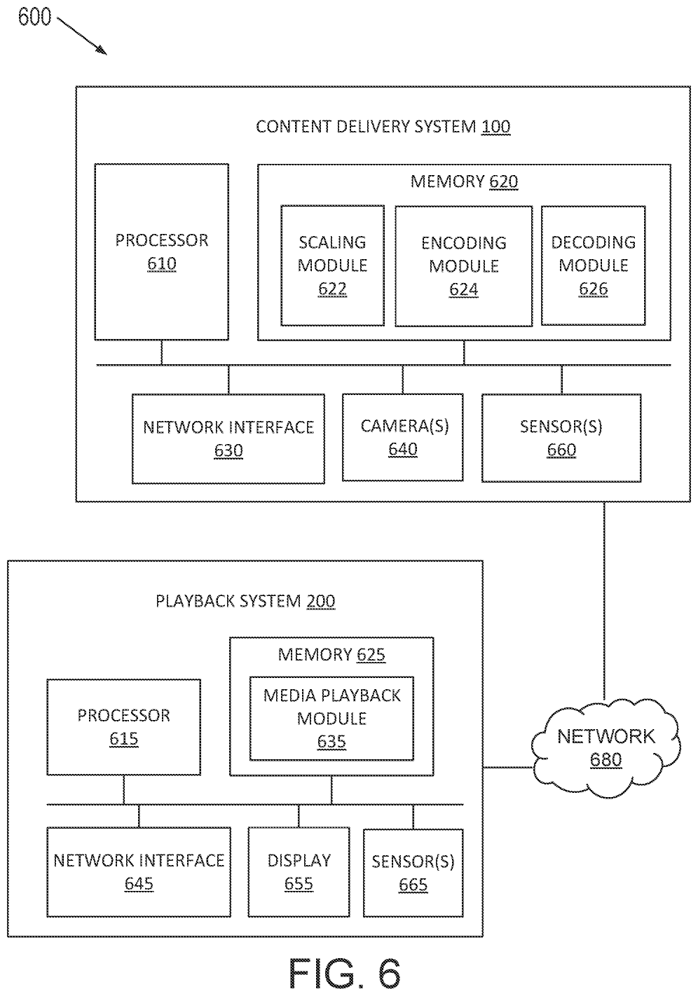

At block 370, the playback system 200 selects at least one of the subframes as a region of interest. The region of interest may correspond to the fovea in the foveation region. As described in FIG. 2, the region of interest is selected based on the head pose/gaze information obtained from at least one user. In some embodiments, the region of interest may correspond to an area of action in an image frame. in this case, “action” may be an area in which attention-grabbing movement is expected to occur. The area of action may be indicated to the playback system 200 based on identified content in the initial image frame or a sequence of movement identified from an image analysis performed by a processor (such as processors 610 or 615 described in reference to FIG. 6).

Finally, at block 380, the playback system 200 generates a combined image frame based on the downscaled image frame and the selected at least one subframe. At this point, the playback system 200 obtains the combined image frame for playback 260 (e.g., a target frame) shown in FIG. 2. Here, the playback system 200 generates the combined image frame to be rendered. Following the example mentioned in reference to block 380, the playback system 200 may determine a rendering procedure for the combined image frame. For example, the playback system 200 may also receive three-dimensional scene geometry from the content delivery system 100 and a mapping of the downscaled image frame 140 and higher quality subframe to the scene geometry. In this case, the rendering procedure may include rendering the scene from a desired viewpoint by mapping the image frame and higher quality subframe to the scene geometry. If desired, the rendering procedure may also blend the image frame and higher quality subframe (e.g., using alpha techniques). The rendering procedure may be predefined or dynamically configured in accordance with one or more image parameters.

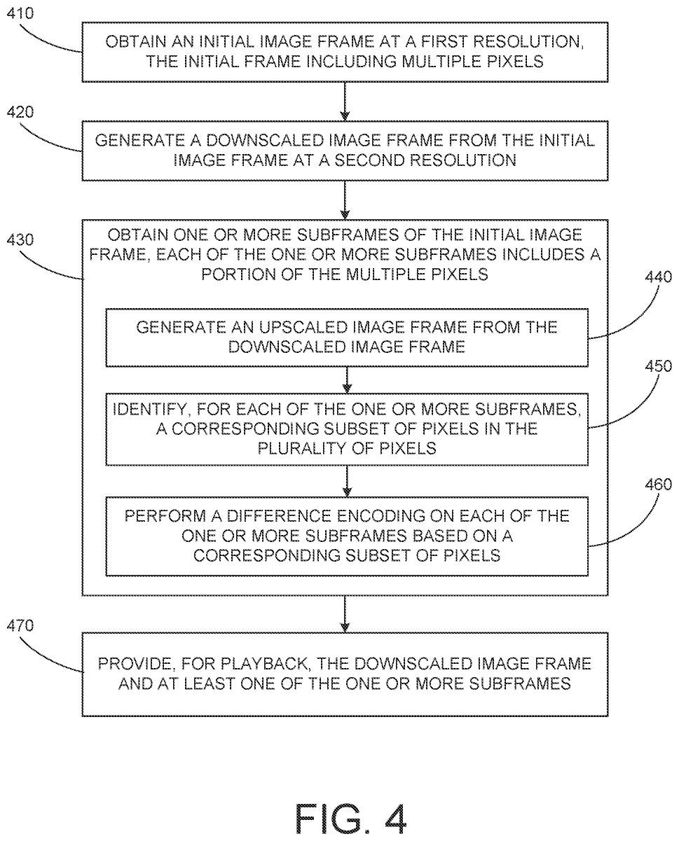

FIG. 4 shows a flowchart of a technique in which multiple layers of a foveated stream are provided for playback in accordance with one or more embodiments. The technique may be performed by the content delivery system 100 described in reference to FIG. 1. Although the various processes depicted in FIG. 4 are illustrated in a particular order, it should be understood that these processes may be performed in a different order. Further, not all the processes may be necessary to be performed. For purposes of explanation, the various processes will be described in the context of the particular components of particular devices; however, it should be understood that the various processes may be performed by additional or alternative components or devices.

In the example of FIG. 4, the content delivery system 100 is described as providing multiple streams of encoded frames at differing resolutions. As described above, the multi-layer foveated streaming techniques may include providing the multiple content streams at differing quality. In this regard image quality may refer to a resolution, frame rate, signal-to-noise ratio (SNR), dynamic range, contrast, color accuracy, distortion, and the like.

The flowchart begins at block 410, where the content delivery system 100 obtains an initial image frame at a first resolution. The initial frame includes multiple pixels. The content delivery system 100 may capture or otherwise obtain frames from media streams of one or more types. As shown in FIGS. 1 and 3, the content delivery system 100 may identify a resolution associated with the initial image frame 130. Further, the content delivery system 100 may identify multiple subframes 131-139 in the initial image frame 130.

The flowchart continues at block 420, where the content delivery system 100 generates a downscaled image frame from the initial image frame at a second resolution. At this stage, the content delivery system 100 may be configured to scale down the initial image frame from the first resolution to a second resolution in the manner described in FIGS. 1 and 3.

The flowchart continues at block 430, where the content delivery system 100 obtains one or more subframes of the initial image frame 130. Each of the subframes include a portion of the pixels. The subframes may be the comparator image subframes described as a result of finding the differences between the subframes 131-139 and the subframes 161-169.

At block 440, the content delivery system 100 generates an upscaled image frame from the downscaled image frame 140. As described above, the downscaled image frame 140 is upscaled to obtain the subframes 161-169. In block 450, the content delivery system 100 identifies, for each of the subframes, a corresponding subset of pixels in the pixels. The subset of pixels are the portions of the subframes 161-169 that correspond to the fovea found in the initial image frame 130. In block 460, the content delivery system 100 performs a difference encoding on each of the subframes based on a corresponding subset of pixels. The comparator image subframes are obtained from using the content comparator 170 that compares the fovea in the initial image frame 130 with a corresponding location in the upscaled image frame 160.

The flowchart concludes at block 470, where the content delivery system 100 provides, for playback, the downscaled image frame 140 and at least one of the subframes. More specifically, the content delivery system 100 transmits encoded versions of the comparator image subframes and the downscaled image frame 140 to the playback system 200.

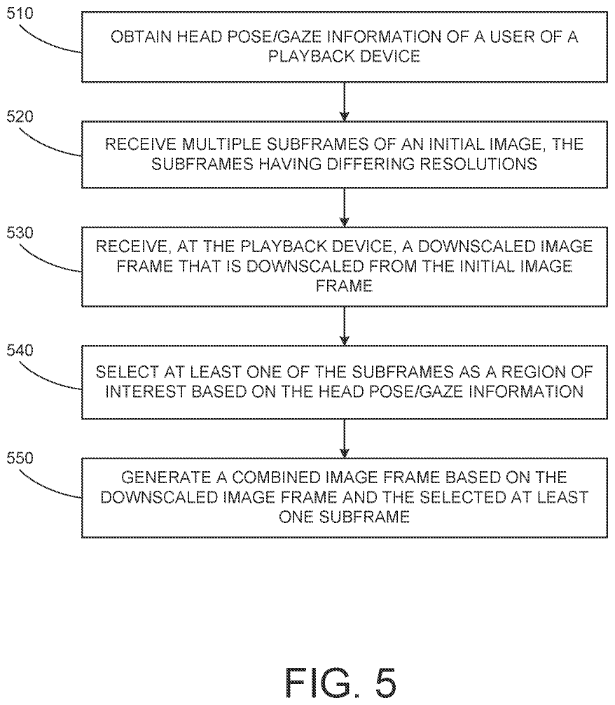

FIG. 5 shows a flowchart of a technique in which a combined image frame is generated based on multiple layers of a foveated stream received for playback in accordance with one or more embodiments. The technique may be performed by the playback system 200 described in reference to FIG. 2. The technique may be performed by the playback system 200 described in reference to FIG. 2. Although the various processes depicted in FIG. 5 are illustrated in a particular order, it should be understood that these processes may be performed in a different order. Further, not all the processes may be necessary to be performed. For purposes of explanation, the various processes will be described in the context of the particular components of particular devices; however, it should be understood that the various processes may be performed by additional or alternative components or devices.

In the example of FIG. 5, the playback system 200 is described as receiving multiple streams of encoded frames at differing resolutions. As described above, the multi-layer foveated streaming techniques may include receiving the multiple content streams at differing quality. In this regard, “quality” may refer to a resolution, frame rate, noise, dynamic range, contrast, color accuracy, distortion, and the like.

The flowchart begins at block 510, where the playback system 200 obtains head pose information and/or gaze information relating to a user. A head pose sensor and/or a gaze tracking system (not shown in FIG. 5) may be configured to provide head pose/gaze information to the subframe selector 220 in the playback system 200.

In block 520, the playback system 200 receives multiple subframes of an initial image 130. The subframes may have differing resolutions. According to one or more embodiments, the subframes may be the encoded comparator image subframes described in reference to FIGS. 1 and 2.

At block 530, the playback system 200 receives a downscaled image frame 140 that is downscaled from the initial image frame. Based on the embodiment, the downscaled image frame 140 may be multiple magnitudes smaller than the initial image frame 130 in size.

At block 540, the playback system 200 selects at least one of the subframes as a region of interest based on the head pose/gaze information. In some embodiments, the subframe selector 220 in the playback system 200 is configured to select the region of interest as an area in the encoded comparator image subframes that matches the head position and/or the gaze of the user.

The flowchart concludes at block 550, the playback system 200 generates a combined image frame based on the downscaled image frame and the selected at least one subframe. At this stage, the playback system 200 combines the ROI 230 and the decoded downscaled image frame 250 to obtain the combined image frame for playback 280 described in reference to FIG. 2.

Referring to FIG. 6, a simplified block diagram of a multi-layer foveated streaming system 700 is depicted, in accordance with one or more embodiments of the disclosure. The multi-layer foveated streaming system 700 may include, and/or be part of, a multifunctional device, such as a mobile phone, tablet computer, personal digital assistant, portable music/video player, wearable device such as a head-mounted device, base station, laptop computer, desktop computer, network device, or any other electronic device. In some embodiments, the multi-layer foveated streaming system 700 may include the content delivery system 100 and the playback system 200 that communicate with one another using network interfaces 630 and 645 via a network 680.

According to one or more embodiments, the content delivery system 100 is capable of providing motion detection from a sensor 660, such as an inertial measurement unit (“IMU”) sensor, or other sensor that detects movement. The motion sensor 660 may detect a change in inertia that indicates a motion event. In this regard, motion parameters may be tracked using sensor data and thresholds associated with these motion parameters may indicate the motion event has occurred. The content delivery system 100 may include a processor 610 (e.g., at least one processor). In some embodiments, the processor 610 may be separate from the content delivery system 100 and may communicate with the content delivery system 100 across the network 680, such as a wired connection, or a wireless short-range connection, among others. For example, in some embodiments, the processor 610 may be part of a smart accessory, such as a smart watch worn on a subject's wrist or arm, a smart headset device worn on the subject's head, a smart hearing device worn on the subject's ear, or any other electronic device that includes the sensor 660 from which at least some motion may be determined. The processor 610 may be a central processing unit (CPU) or a system-on-chip such as those found in mobile devices and include one or more dedicated graphics processing units (GPUs). Further, the processor 610 may include multiple processors of the same or different type.

The content delivery system 100 may also include a memory 620 (e.g., a storage device). The memory 620 may include one or more different types of storage devices, which may be used for performing device functions in conjunction with the processor 610. For example, the memory 620 may include cache, ROM, RAM, or any kind of transitory or non-transitory computer readable storage medium capable of storing computer readable code. The memory 620 may store various programming modules for execution by the processor 610.

The content delivery system 100 may include a scaling module 622, an encoding module 624, and a decoding module 626 that are configured to perform one or more of the scaling/encoding/decoding functionalities described in reference to FIGS. 1-5. The scaling module 622 may perform the functionality described in reference to scaler 105 in FIG. 1. The scaling module 622 may be configured to scale down the initial frame 130 into the downscaled image frame 140. The multiple frames may include image data representative of different sets of image parameters. Further, the processor 610 may be configured to determine whether the multiple frames include the different types of image parameters based on a scene analysis of the multiple frames.

The encoding module 624 may perform the functionality described in reference to encoder 115 in FIG. 1. The encoding module 624 may be configured to encode the comparator image subframes and the downscaled image frame 140. The decoding module 626 may perform the functionality described in reference to decoder 150 in FIG. 1. The decoding module 626 may be configured to decode the downscaled image frame 140.

The content delivery system 100 may include at least one camera 640 or other sensors, from which depth of a scene may be determined. In one or more embodiments, the camera 640 may be a traditional RGB camera, a depth camera, or other camera device by which image information may be captured. Further, the camera 640 may include a stereo or other multi-camera system, a time-of-flight camera system, or the like which capture images from which depth information of a scene may be determined.

According to one or more embodiments, the playback system 200 is configured to combine the subframes received from the content delivery system 100. The playback system 200 may act as a playback device that receives the combined media stream from the content delivery system 100 and combines multiple subframes in the manner described in FIGS. 2, 3, and 5.

The playback system 200 may include a processor 615 (e.g., at least one processor). The processor 615 may perform one or more functionalities described in reference to the processor 615. The playback system 200 may also include a memory 625. The memory 625 may include one or more different types of storage devices, which may be used for performing device functions in conjunction with the processor 615. As described in reference to the memory 620, the memory 620 may store various programming modules for execution by the processor 615. In some embodiments, the memory 625 may include a media playback module 635 that is configured to perform one or more of the decoding functionalities described in reference to decoder 205 in FIG. 2.

The media playback module 635 may be executed to perform the functionality described in reference to decoder 205 in FIG. 2. Specifically, the media playback module 635 may decode and render portions of the combined image frame for playback 260 after. As described above, the media playback module 635 may be configured to perform one more rendering operations based on a predefined rendering configuration for a foveated region. The playback system 200 may include a display 655 configured to show a visual representation of the rendered portions of the combined image frame for playback 260.

Although the content delivery system 100 is depicted as comprising the numerous components described above, in one or more embodiments, the various components may be distributed across multiple systems or devices. Particularly, in one or more embodiments, one or more of the scaling module 622, the encoding module 624, and the decoding module 626 may be distributed differently across multiple devices. Thus, the content delivery system 100 may not be needed to perform one or more techniques described herein, according to one or more embodiments. Accordingly, although certain operations are described herein with respect to the particular systems as depicted, in one or more embodiments, the various operations may be made differently directed based on the differently distributed functionality. Further, additional components may be used, some combination of the functionality of any of the components may be combined.

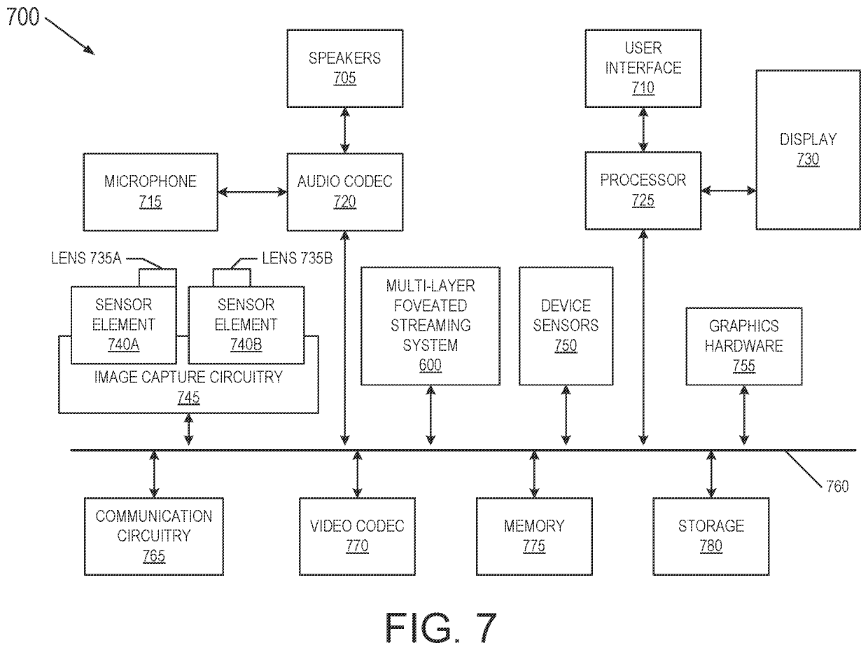

Referring now to FIG. 7, a simplified functional block diagram of illustrative multifunction electronic device 700 is shown according to one or more embodiments. For example, the multi-layer foveated streaming system 600 may include one or more multifunctional electronic devices or may have some or all the described components of a multifunctional electronic device described herein. The multifunction electronic device 700 may include a processor 725, a display 730, a user interface 710, device sensors 750, graphics hardware 755, an image capture circuitry 745, device sensors (e.g., proximity sensor/ambient light sensor, accelerometer and/or gyroscope), a microphone 715, audio codec(s) 720, speaker(s) 705, communications circuitry 765, the multi-layer foveated streaming system 600 (e.g., including camera 640 or a camera system), video codec(s) 770 (e.g., in support of digital an image capture unit), a memory 775, a storage 780, and a communications bus 760. The multifunction electronic device 700 may be, for example, a digital camera or a personal electronic device such as a personal digital assistant (PDA), personal music player, mobile telephone, or a tablet computer.

The processor 725 may execute instructions necessary to carry out or control the operation of many functions performed by the multifunction electronic device 700 (e.g., such as the generation and/or processing of media content types as disclosed herein). The processor 725 may, for instance, drive the display 730 and receive user input from the user interface 710. The user interface 710 may allow a user to interact with multifunction electronic device 700. For example, the user interface 710 may take a variety of forms, such as a button, keypad, dial, a click wheel, keyboard, display screen and/or a touch screen. The processor 725 may also, for example, be a system-on-chip such as those found in mobile devices and include a dedicated graphics processing unit (GPU). The processor 725 may be based on reduced instruction-set computer (RISC) or complex instruction-set computer (CISC) architectures or any other suitable architecture and may include one or more processing cores. The graphics hardware 755 may be special purpose computational hardware for processing graphics and/or assisting the processor 625 to process graphics information. In one embodiment, the graphics hardware 755 may include a programmable GPU.

In one or more embodiments, the image capture circuitry 745 may include two (or more) lens assemblies (e.g., sensor elements 740A and 74013 with corresponding lenses 735A and 735B), where each lens assembly may have a separate focal length. For example, one lens assembly may have a short focal length relative to the focal length of another lens assembly. Each lens assembly may have a separate associated sensor element. Alternatively, two or more lens assemblies may share a common sensor element. The image capture circuitry 745 may capture still and/or video images in collaboration with the multi-layer foveated streaming system 600. Output from the image capture circuitry 745 may be processed, at least in part, by video codec(s) 720 and/or the processor 725, and/or the graphics hardware 755. Images so captured may be stored in the memory 775 and/or the storage 780.

The memory 775 may include one or more different types of media used by the processor 725 and the graphics hardware 755 to perform device functions. For example, the memory 775 may include memory cache, read-only memory (ROM), and/or random access memory (RAM). The storage 780 may store media (e.g., audio, image, and video files), computer program instructions or software, preference information, device profile information, and any other suitable data. The storage 780 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). The memory 775 and the storage 780 may be used to tangibly retain computer program instructions or code organized into one or more modules and written in any desired computer programming language. When executed by, for example, the processor 725 such computer program code may implement one or more of the methods described herein.

While FIGS. 1-7 show various configurations of components, other configurations may be used without departing from the scope of the disclosure. For example, various components in FIGS. 1-7 (e.g., the content delivery system 100 from FIG. 1 and the playback system 200 of FIG. 2) may be combined to create a single component. As another example, the functionality performed by a single component may be performed by two or more components.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory computer readable medium comprising instructions that, when executed by at least one computer processor, cause the at least one computer processor to:
obtain an initial image frame at a first resolution, wherein the initial image frame comprises a first plurality of pixels;
generate a downscaled image frame from the initial image frame at a second resolution;
obtain one or more subframes of the initial image frame, wherein each of the one or more subframes comprises a portion of the plurality of pixels; and
transmit, to a playback device, the downscaled image frame and at least one of the one or more subframes,
wherein the downscaled image frame and the at least one of the one or more subframes are combinable to form a target frame comprising subframes of differing resolutions.

2. The non-transitory computer readable medium of claim 1, wherein, to obtain the one or more subframes, the at least one computer processor is further caused to:
generate an upscaled image frame from the downscaled image frame, wherein the upscaled image frame comprises a second plurality of pixels;
identifying, for each of the one or more subframes, a corresponding subset of pixels in the second plurality of pixels; and
perform a difference encoding on each of the one or more subframes based on the corresponding subset of pixels,
wherein the at least one of the one or more subframes comprise the difference encoded one or more subframes.

3. The non-transitory computer readable medium of claim 2, wherein, to generate the upscaled image frame, the at least one computer processor is further caused to:
encode the downscaled image frame to obtain an encoded downscaled image frame;
apply the encoded downscaled image frame to a decoder to obtain a decoded downscaled image frame; and
apply a scaler to the decoded downscale image to obtain the upscaled image frame.

4. The non-transitory computer readable medium of claim 1, wherein the initial image frame comprises a foveated image frame generated from image data captured from a plurality of cameras.

5. The non-transitory computer readable medium of claim 1, wherein the at least one of the one or more subframes corresponds to a region of interest in the initial image frame.

6. The non-transitory computer readable medium of claim 5, wherein the region of interest is determined based on head pose information or gaze information obtained by the playback device.

7. A non-transitory computer readable medium comprising instructions that, when executed by at least one computer processor, cause the at least one computer processor to:
receive, at a playback device, a downscaled image frame having a first resolution;
receiving a plurality of subframes of an initial image frame from which the downscaled image frame was downscaled, wherein the plurality of subframes comprise differing resolutions;
select at least one of the plurality of subframes as a region of interest; and
generate a combined image frame based on the downscaled image frame and the selected at least one subframe.

8. The non-transitory computer readable medium of claim 7, wherein the at least one computer processor is further caused to:
obtain head pose information or gaze information of a user of the playback device; and
select the at least one of the plurality of subframes based on the head pose information or the gaze information.

9. The non-transitory computer readable medium of claim 7, wherein the at least one computer processor is further caused to:
identify head pose information or gaze information of a user of the playback device; and
transmitting a request for the plurality of subframes based on the head pose information or the gaze information.

10. The non-transitory computer readable medium of claim 7, wherein, to generate the combined image frame, the at least one computer processor is further caused to:
decode the downscaled image frame; and
decode the at least one of the plurality of subframes in accordance with the downscaled image frame.

11. The non-transitory computer readable medium of claim 10, wherein the at least one of the plurality of subframes are difference encoded based on a corresponding subset of pixels in an upscaled image frame generates from the downscaled image frame at a second resolution.

12. The non-transitory computer readable medium of claim 7, the at least one computer processor is further caused to:
determine a power target for the playback device;
select a subframe size in accordance with the power target; and
transmit a request for the at least one of the plurality of subframes in accordance with the selected subframe size.

13. The non-transitory computer readable medium of claim 7, wherein the at least one computer processor is further caused to:
display the combined image frame on a display device of the playback device.

14. A non-transitory computer readable medium comprising instructions that, when executed by at least one computer processor, cause the at least one computer processor to:
obtain an initial image frame at a first quality, wherein the initial image frame comprises a first plurality of pixels;
generate a downscaled image frame from the initial image frame at a second quality;
obtain one or more subframes of the initial image frame, wherein each of the one or more subframes comprises a portion of the plurality of pixels; and
transmit, to a playback device, the downscaled image frame and at least one of the one or more subframes,
wherein the downscaled image frame and the at least one of the one or more subframes are combinable to form a target frame comprising subframes of differing quality, and
wherein the target frame comprises an area having the first quality surrounded by areas having the second quality.

15. The non-transitory computer readable medium of claim 14, wherein, to obtain the one or more subframes, the at least one computer processor is further caused to:
generate an upscaled image frame from the downscaled image frame, wherein the upscaled image frame comprises a second plurality of pixels;
identifying, for each of the one or more subframes, a corresponding subset of pixels in the second plurality of pixels; and
perform a difference encoding on each of the one or more subframes based on the corresponding subset of pixels,
wherein the at least one of the one or more subframes comprise the difference encoded one or more subframes.

16. The non-transitory computer readable medium of claim 15, wherein, to generate the upscaled image frame, the at least one computer processor is further caused to:
encode the downscaled image frame to obtain an encoded downscaled image frame;
apply the encoded downscaled image frame to a decoder to obtain a decoded downscaled image frame; and
apply a scaler to the decoded downscaled image to obtain the upscaled image frame.

17. The non-transitory computer readable medium of claim 14, wherein the initial image frame comprises a foveated image frame generated from image data captured from a plurality of cameras.

18. The non-transitory computer readable medium of claim 14, wherein the at least one of the one or more subframes corresponds to a region of interest in the initial image frame.

19. The non-transitory computer readable medium of claim 18, wherein the region of interest is the area having the first quality.

20. The non-transitory computer readable medium of claim 18, wherein the region of interest is determined based on head pose information or gaze information obtained by the playback device.
